(19) United States
(12) Patent Application Publication
(10) Pub. No.: US 2006/0050020 A1
(43) Pub. Date: Mar. 9, 2006

(54) Plasma display apparatus and driving method thereof

(76) Inventor: Seong Hak Moon, Seoul (KR)

Correspondence Address: MCKENNA LONG & ALDRIDGE LLP;Song K. Jung, 1900 K Street, N.W., Washington, DC, 20006, US

(21) Appl. No.: 11/218,563

(22) Filed: Sep. 6, 2005

(30) Foreign Application Priority Data
Sep. 7, 2004 (KR) 10-2004-0071474

(51) Int. Cl. G09G 3/28

(52) U.S. Cl. 345/60

(57) ABSTRACT

The present invention relates to a flat plate display apparatus and more specifically to a flat plate display apparatus capable of suppressing misdischarge and improving productivity. The flat plate display apparatus according to the present invention comprises a display panel, frame mounted in the back side of the display panel, and at least two heat conductive sheets formed in the face between the display panel and the frame, wherein the heat conductive sheets are separated and spaced at a predetermined distance. The effect of the present invention improves the structure of the flat plate display apparatus so that it can improve work efficiency and suppress the temperature difference of the flat plate display panel.

This Nonprovisional application claims priority under 35 U.S.C. § 119(a) on Patent Application No. 2004-0071474 filed in Korea on Sep. 7, 2004 the entire contents of which are hereby incorporated by reference.

### TECHNICAL FIELD

The present invention relates to a plasma display apparatus and driving method thereof, and more specifically to a plasma display apparatus and driving method thereof to perform a reset driving.

### BACKGROUND OF THE IEVENTION

FIG. 1 is a circuit diagram of a plasma display apparatus of the prior art. FIG. 2 is a driving waveform diagram according to the operation of a plasma display apparatus of the prior art.

A fifth switch S5 and a seventh switch S7 are turned-on during a setup period. At this time, a sustain voltage Vs is supplied from a sustain pulse supplying unit 40. The sustain voltage supplied from the sustain pulse supplying unit 40 is supplied to scan electrodes via an internal diode of a sixth switch Q6, the seventh switch Q7 and a second selecting unit Q15 of a drive integrated circuit 52. Therefore, as illustrated in FIG. 2, the voltage of the scan electrodes Y is rapidly risen to Vs.

Meanwhile, since the sustain voltage Vs is supplied to a negative polarity terminal of a second capacitor C2, the second capacitor C2 supplies the voltage of Vs+Vsetup to the fifth switch Q5. The fifth switch Q5 supplies the voltage supplied from the second capacitor C2 to a first node point n1 with a predetermined gradient, while the channel width thereof is controlled by a first variable resistor VR1 positioned in front of the fifth switch.

The voltage applied to the first node point n1 with a predetermined gradient is supplied to the scan electrodes via the seventh switch Q7 and the second selecting unit Q15 of the drive integrated circuit 52. Through such a process, as illustrated in FIG. 2, a ramp-up pulse is supplied to the scan electrodes Y.

After the ramp-up pulse is supplied to the scan electrodes Y, the fifth switch Q5 is turned-off. When the fifth switch Q5 is turned-off, only the voltage of the Vs supplied from the sustain pulse supplying unit 40 is applied to the first node point n1, and accordingly, as illustrated in FIG. 2, the voltage of the scan electrodes Y is rapidly fallen to the Vs.

Thereafter, the seventh switch Q7 is turned-off and at the same time, a tenth switch Q10 is turned-on, during a setdown period. The tenth switch Q10 falls the voltage of a second node n2 to a write scan voltage −Vw (or setdown voltage source) with a predetermined gradient, while the channel width thereof is controlled by a second variable resistor VR2 positioned in front of the tenth switch. Accordingly, as illustrated in FIG.2, the ramp-down pulse is supplied to the scan electrodes Y and the potential of the scan electrodes Y falls to the −Vw.

Here, the seventh switch Q7 comprises the internal diode having a different direction from the sixth switch Q6, and thereby, prevents the voltage applied to the second node n2 from being supplied to a ground potential GND via the internal diode of the sixth switch Q6 and the internal diode of the fourth switch Q4.

The scan standard voltage supplying unit 50 comprises a third capacitor C3 connected between a scan bias voltage source Vsc and the second node n2, and an eighth switch Q8 and a ninth switch Q9 connected between the scan bias voltage source Vsc and the second node n2.

The eighth switch Q8, supplies the voltage of the scan bias voltage source Vsc to the drive integrated circuit 52, while being switched over by a control signal supplied from a timing controller during a selective write and erasing address, as illustrated in FIG. 2. The third capacitor C3 adds the voltage applied to the second node n2 and the voltage value of the scan bias voltage source Vsc to supply it to the eight switch Q8. The ninth switch Q9 is turned-on together with a fourteenth switch Q14, the seventh switch Q7, the sixth switch Q6 and the fourth switch Q4, such that the potential of the scan electrode Y becomes a ground level.

In the driving apparatus of the plasma display panel of the prior art operating as above, since the voltage size (Vsetup+Vs), at which a ramp-up waveform arrives, is large and the rising time thereof is long, the current flowing into the fifth switch Q5 is gradually increased and thus, high heat is generated. Therefore, the fifth switch Q5 must withstand a high voltage and a high current.

Therefore, since the fifth switch Q5 is a high expensive switching element with a very superior performance, the manufacturing cost of the plasma display panel is increased. Also, due to noise generated in response to the operation of the fifth switch Q5, peripheral switch elements adjacent thereto suffer from bad influences.

Accordingly, in order to isolate the fifth switch Q5 and the switches adjacent thereto, the sixth switch Q6 and the seventh switch Q7 should be provided separately.

In particular, when the ramp-up pulse is supplied, since the sixth switch is turned-off and the sustain voltage Vs is thereby applied through the internal diode of the sixth switch Q6, the sixth switch Q6 isolates an energy recovery circuit 40 and a setup supplying unit 42.

At this time, since the setup voltage Vsetup and the sustain voltage Vs pass through the sixth switch Q6, the sixth switch Q6 should be a high withstand voltage switch withstanding voltage higher than the setup voltage applying a setup waveform, resulting in the problems that the manufacturing cost of the plasma display panel is increased and energy loss is significantly occurred.

Also, the seventh switch Q7 comprises the internal diode having a different direction from the sixth switch Q6, and thereby, prevents the voltage applied to the second node n2 from being supplied to a ground potential GND via the internal diode of the sixth switch Q6 and the internal diode of the fourth switch Q4. During a setdown period, the voltage of the Vs is applied to the first node n1 and the write scan voltage −Vw is applied to the second node n2. Here, if the voltage of the Vs is set up as about 180V and the write scan voltage −Vw is set up as about −70V, the seventh switch Q7 should have an withstand voltage on the order of about 250V (300V in consideration of a substantial driving voltage margin). That is, in the prior art, the seventh switch Q7 should be provided with a switching elements having a high withstand voltage, resulting in a problem that the manufacturing cost of the plasma display panel is increased.

In addition, it has further caused the problem that the conventional driving apparatus needs a separate setup voltage source Vsetup for forming the ramp-up waveform.

### SUMMARY OF THE INVENTION

Accordingly, an object of the present invention is to solve at least the problems and disadvantages of the background art

It is an object of the present invention to provide a plasma display apparatus and a driving method thereof capable of lowering the driving voltage applied to the scan electrode.

It is an object of the present invention to provide a plasma display apparatus and a driving method thereof capable of reducing the manufacturing cost.

It is an object of the present invention to provide a plasma display apparatus and a driving method thereof capable of reducing the generation of heat.

It is an object of the present invention to provide a plasma display apparatus and a driving method thereof, which does not need a separate setup voltage sources for forming a ramp-up waveform.

A plasma display apparatus according to the present invention comprises: a plasma display panel comprising a scan electrode and a sustain electrode; a first ramp pulse applying unit applying a first ramp-up pulse to the scan electrode; a voltage applying unit applying a first negative voltage to the sustain electrode while the first ramp-up pulse is applied to the scan electrode; and a second ramp pulse applying unit applying a second ramp-up pulse to the sustain electrode after the first negative voltage is applied.

A driving method of a plasma display apparatus according to the present invention comprises the steps of: applying the first ramp-up pulse to the first scan electrode; applying the first negative voltage to the sustain electrode while the first ramp-up pulse is applied to the scan electrode; and applying the second ramp-up pulse to the sustain electrode, after the first negative voltage is applied.

The present invention is able to lower the driving voltage applied to the scan electrode by applying a driving pulse to the scan electrode and the sustain electrode in a setup period and a setdown period.

The present invention is able to reduce the manufacturing cost by applying the driving pulse to the scan electrode and the sustain electrode in a setup period and a setdown period.

The present invention is able to reduce the generation of heat by applying the driving pulse to the scan electrode and the sustain electrode in a setup period and a setdown period.

The present invention does not need a separate voltage source by using a sustain voltage for forming the ramp-up pulse.

### BRIEF DESCRIPTION OF THE DRAWINGS

The invention will be described in detail with reference to the following drawings in which like numerals refer to like elements.

FIG. 1 is a circuit diagram illustrating a plasma display apparatus of the prior art.

FIG. 2 illustrates a driving waveform diagram according to the operation of a plasma display apparatus of the prior art.

FIG. 3 illustrates a first embodiment of a plasma display apparatus according to the present invention.

FIG. 4 is a driving waveform diagram illustrating the operation of a plasma display apparatus according to the first embodiment of the present invention.

FIG. 5 illustrates a second embodiment of a plasma display apparatus according to the present invention.

FIG. 6 is a driving waveform diagram illustrating the operation of a plasma display apparatus according to the second embodiment of the present invention.

FIG. 7 illustrates a third embodiment of a plasma display apparatus according to the present invention.

FIG. 8 is a driving waveform diagram illustrating the operation of a plasma display apparatus according to the third embodiment of the present invention.

### DETAILED DESCRIPTION OF THE INVENTION

Preferred embodiments of the present invention will be described in a more detailed manner with reference to the drawings.

A plasma display apparatus according to the present invention comprises: a plasma display panel comprising a scan electrode and a sustain electrode; a ramp pulse applying unit applying a first ramp-up pulse to the scan electrode; a voltage applying unit applying a first negative voltage to the sustain electrode while the first ramp-up pulse is applied to the scan electrode; and a second ramp pulse applying unit applying a second ramp-up pulse to the sustain electrode after the first negative voltage is applied.

The first ramp pulse applying unit applies a first ramp-up pulse rising from a ground level voltage to a first setup voltage to the scan electrode.

The first ramp pulse applying unit comprises a first setup switch, which generates the first ramp-up pulse by the first setup voltage applied to one terminal thereof and applies the first ramp-up pulse to the scan electrode through other terminal thereof.

The first ramp pulse applying unit applies the first ramp-up pulse rising from a ground level voltage to a sustain voltage to the scan electrode.

The first ramp pulse applying unit comprises a first setup switch, which generates the first ramp-up pulse by the sustain voltage applied to one terminal thereof and applies the first ramp-up pulse to the scan electrode through other terminal thereof.

The second ramp pulse applying unit applies a second ramp-up pulse rising from a ground level voltage to a second setup voltage to the sustain electrode.

The second ramp pulse applying unit comprises a second setup switch, which generates the second ramp-up pulse by the second setup voltage applied to one terminal thereof and applies the second ramp-up pulse to the sustain electrode through other terminal thereof.

The second ramp pulse applying unit applies the second ramp-up pulse rising from a ground level voltage to a sustain voltage to the sustain electrode.

The second ramp pulse applying unit comprises a second setup switch, which generates the second ramp-up pulse by the sustain voltage applied to one terminal thereof and applies the second ramp-up pulse to the sustain electrode through other terminal thereof.

The second ramp pulse applying unit further comprises a bias voltage applying unit applying a ground level voltage to the scan electrode, after applying the second ramp-up pulse.

The plasma display apparatus further comprises a sustain pulse supplying unit supplying a sustain pulse to the sustain electrode, and the second ramp pulse applying unit applies the second ramp-up pulse when the sustain pulse supplying unit recovers energy from the sustain electrode.

The second ramp pulse applying unit comprises a second setup switch being turned-on upon recovering the energy, by connecting one terminal thereof to the sustain electrode and the other terminal thereof to the ground.

The first setup switch operates in an active region.

The second setup switch operates in an active region.

A driving method of a plasma display apparatus according to the present invention comprises the steps of: applying a first ramp-up pulse to a first scan electrode; applying a first negative voltage to a sustain electrode while the first ramp-up pulse is applied to the scan electrode; and applying a second ramp-up pulse to the sustain electrode after the first negative voltage is applied.

The first ramp-up pulse rises from a ground level to a first setup voltage.

The first ramp-up pulse rises from a ground level to a sustain voltage.

The second ramp-up pulse rises from a ground level to a second setup voltage.

The second ramp-up pulse rises from a negative sustain voltage to a ground level.

The driving method further comprises applying a ground level voltage to the scan electrode after applying the second ramp-up pulse.

Hereinafter, the concrete embodiments of the present invention will be described with reference made to the accompanying drawings.

### FIRST EMBODIMENT

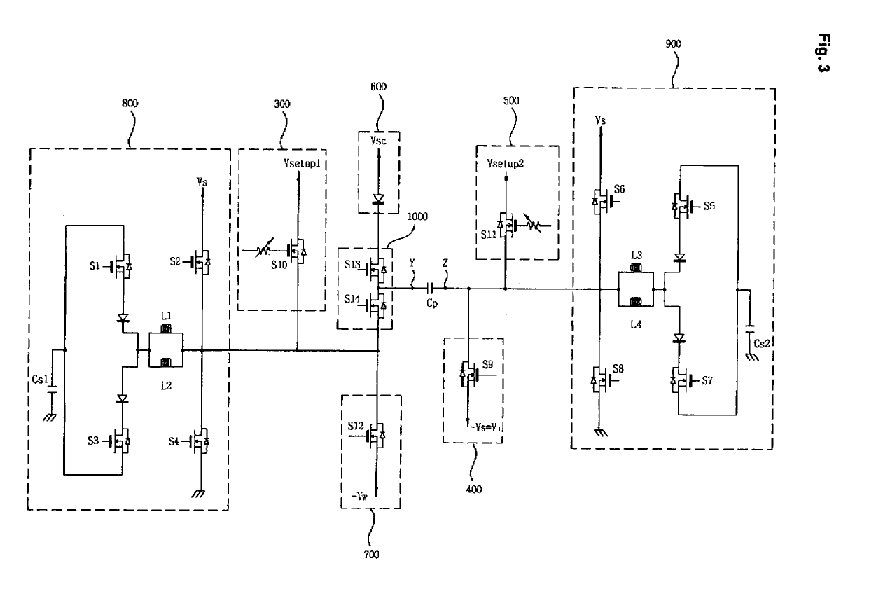

FIG. 3 is a first embodiment of a plasma display apparatus according to the present invention. As illustrated in FIG. 3, a driving apparatus of a plasma display panel according to the first embodiment of the present invention comprises: a plasma display panel Cp, a first ramp pulse applying unit 300, a voltage applying unit 400, a second ramp pulse applying unit 500, a bias voltage applying unit 600, a scan pulse supplying unit 700, a first sustain pulse supplying unit 800 and a second sustain pulse supplying unit 900.

The plasma display panel Cp comprises a scan electrode Y and a sustain electrode Z.

The first ramp pulse applying unit 300 applies the first ramp-up pulse rising up to a first setup voltage Vsetup1 to the scan electrode Y. The first ramp pulse applying unit 300 applies the first ramp-up pulse, generated by turning-on a tenth switch S10 that is the first setup switch operating in an active region, to the scan electrode Y.

The voltage applying unit 400 applies a first negative voltage V1 to the sustain electrode while the first ramp-up pulse is applied to the scan electrode Y. The voltage applying unit 400 applies the first negative voltage V1 to the sustain electrode Z by turning-on of a ninth switch S9 that is the switch for applying voltage. At this time, preferably, the first negative voltage V1 is a negative sustain voltage −Vs. The sustain voltage Vs is a voltage for sustaining the sustain discharge of the plasma display panel.

The second ramp pulse applying unit 500 applies a second ramp-up pulse rising up to a second setup voltage Vsetup2 to the sustain electrode Z, after the first negative voltage V1 is applied. At this time, the second ramp pulse applying unit 500 applies the second ramp-up pulse, generated by turning-on a eleventh switch S11 that is the second setup switch operating in an active region, to the sustain electrode Z.

The bias voltage applying unit 600 applies a scan bias voltage Vsc to the scan electrode Y in an addressing period, after the second ramp-up pulse is applied by means of the second ramp-pulse applying unit 500.

The scan pulse supplying unit 700 supplies the voltage −Vw for scan pulse in order to perform an addressing on the cell positioned on the selected scan electrode. At this time, the application of the voltage for scan pulse−Vw is done by turning-on a twelfth switch S12. A data pulse synchronizing with a scan pulse supplied by the scan pulse supplying unit 700 is applied to an address electrode (not shown) and thereby, an addressing is done.

The first sustain pulse supplying unit 800 supplies the energy stored in a capacitor Csl for recovering and storing energy by using a resonance between a first inductor L1 and a second inductor L2 to the scan electrode Y, and recovers it from the scan electrode Y by using a resonance between the first inductor L1 and the second inductor L2, after an addressing period, thereby supplying a sustain pulse.

The second sustain pulse supplying unit 900 applies the sustain voltage Vs, i.e., a bias voltage, to the sustain electrode Z, after the second ramp-up pulse is applied by the second ramp pulse applying unit 500, and applies the sustain pulse alternating with the sustain pulse supplied by the first sustain pulse supplying unit 800 to the sustain electrode Z.

The reference numeral 1000 is a scan driver. The scan driver 1000 Y turns-on or turns-off a thirteenth switch S13, i.e., a first selection switch, and a fourteenth switch S14, i.e., a second selection switch for applying a driving waveform to the scan electrode.

The operation associated with a driving apparatus of a plasma display penal according to the present invention will be described below in detail with reference to the drawing.

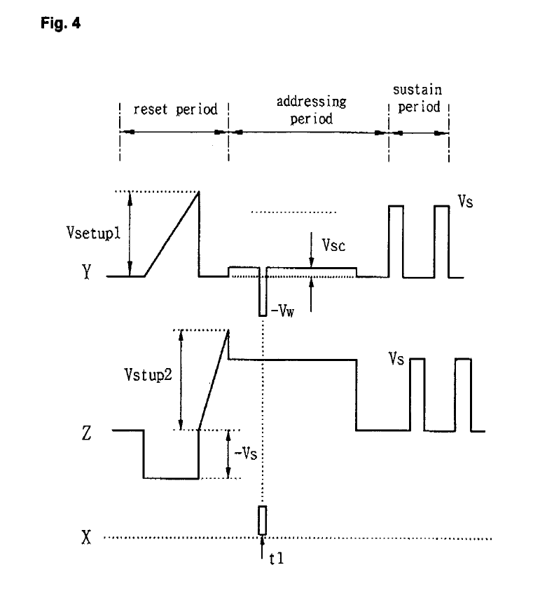

FIG. 4 is a driving waveform diagram illustrating the operation of a plasma display apparatus according to the first embodiment of the present invention.

First, the voltage applying unit 400 applies a negative sustain voltage −Vs, i.e., a first negative voltage V1, to the sustain electrode Z by turning-on the ninth switch S9 that is the switch for applying voltage. At the same time, the first ramp pulse applying unit 300 applies the first ramp-up pulse rising from a ground level voltage to the first setup voltage Vsetup1 to the scan electrode Y. The first ramp pulse applying unit 300 is able to apply the first ramp-up pulse rising from a ground level voltage to the first setup voltage Vsetup1, because the second switch S2 of the first sustain pulse supplying unit 800 is turned-off.

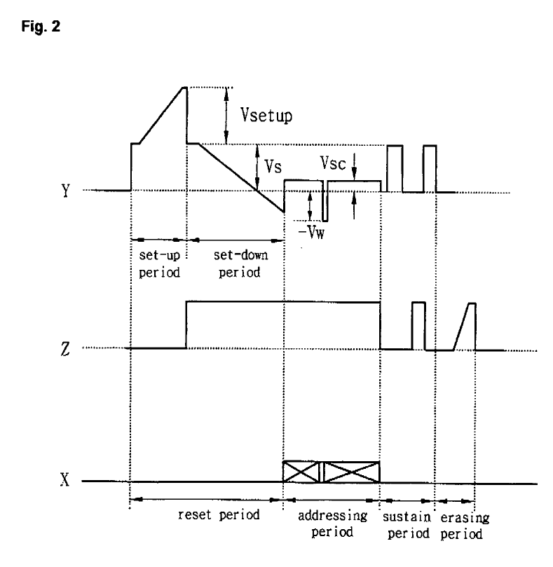

As above, by simultaneously applying the first ramp-up pulse and the negative sustain voltage −Vs to the scan electrode Y, the potential difference between the scan electrode Y and the sustain electrode Z is the same with the waveform of the driving pulse applied to the scan electrode Y in the setup period of FIG. 2.

(75) As above, by applying each of the first ramp-up pulse and the negative sustain voltage −Vs to the scan electrode Y and the sustain electrode Z, respectively, the sixth switch S6 included in the conventional plasma display apparatus is not needed. That is, the sixth switch S6 included in the conventional plasma display apparatus should be a high withstand voltage switch, in order to pass through the setup voltage Vsetup and the sustain voltage Vs. However, the plasma display apparatus of the present invention separates the first ramp-up pulse and the negative sustain voltage −Vs and applies each of them to the scan electrode Y and the sustain electrode Z, respectively, such that any high withstand voltage switch such as the sixth switch S6 is not needed.

Thereafter, the second ramp pulse applying unit 500 applies the second ramp-up pulse rising up to the second setup voltage Vsetup2 to the sustain electrode Z. Therefore, the potential difference between the scan electrode Y and the sustain electrode Y is the same with the waveform until the ending point of setdown period, as illustrated in FIG. 3.

Next, the bias voltage applying unit 600 applies the scan bias voltage Vsc to the scan electrode Y in an addressing period. In addition, the scan pulse supplying unit 700 supplies the voltage for scan pulse −Vw, in order to perform an addressing on the cell on the selected scan line. And, the second sustain pulse supplying unit 900 applies the sustain voltage Vs to the sustain electrode Z through the turned-on sixth switch S6.

Accordingly, the scan bias voltage Vsc or the voltage for scan pulse −Vw is applied to the scan electrode Y, and the sustain voltage Vs playing a role of a bias voltage is applied to the sustain electrode Z, in an addressing period, as illustrated in FIG. 4.

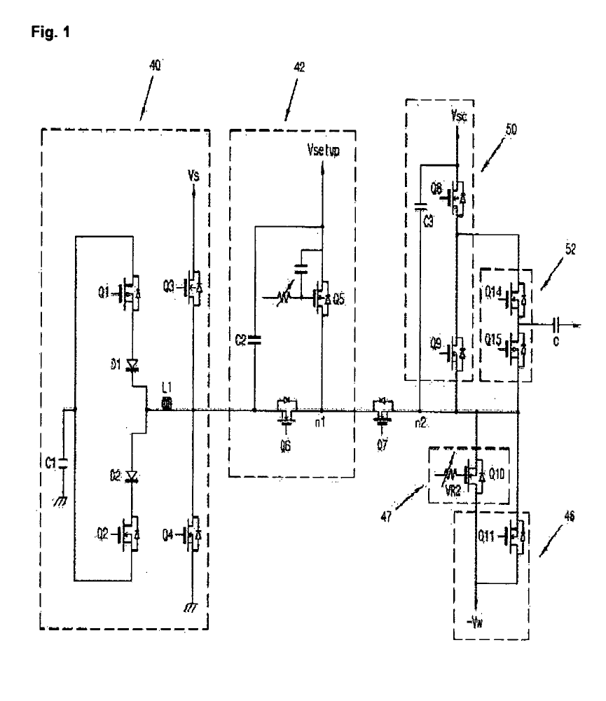

When the voltage for scan pulse −Vw is applied as above, the second switch S2 of the first sustain pulse supplying unit 800 becomes a turn-off status. That is, the conventional plasma display apparatus applies the voltage of Vs to the first node n1 and the write scan voltage −Vw to the second node n2 in the setdown period, as illustrated in FIG. 1, such that the seventh switch S7 with the characteristic withstanding high voltage is needed. However, the plasma display apparatus of the present invention does not need a high withstand voltage switching element such as the seventh switch S7.

Also, since the scan bias voltage Vsc is applied to the scan electrode Y through the thirteenth switch S13 of the scan driver 1000, the eighth switch S8 of the conventional driving apparatus, as illustrated in FIG. 1, is not needed. Also, as illustrated in FIG. 3, since the scan electrode Y becomes a ground level by the turn-on of the fourth switch S4 and the fourteenth switch S14, the ninth switch S9 of FIG. 1 is not needed.

### SECOND EMBODIMENT

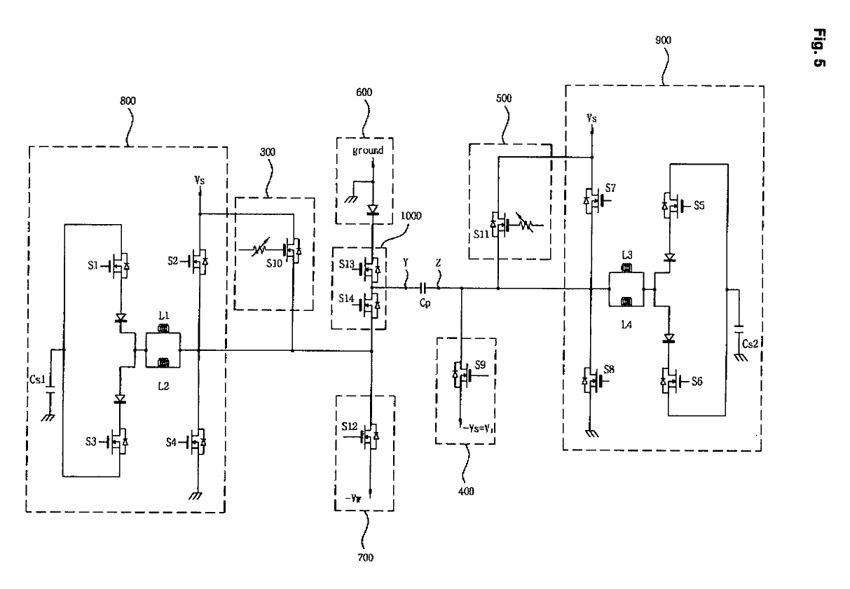

FIG. 5 is a second embodiment of a plasma display apparatus according to the present invention. As illustrated in FIG. 5, a driving apparatus of a plasma display panel according to the second embodiment of the present invention comprises: a plasma display panel Cp, a first ramp pulse applying unit 300, a voltage applying unit 400, a second ramp pulse applying unit 500, a bias voltage applying unit 600, a scan pulse supplying unit 700, a first sustain pulse supplying unit 800 and a second sustain pulse supplying unit 900.

The plasma display panel Cp comprises a scan electrode Y and a sustain electrode Z.

The first ramp pulse applying unit 300 applies the first ramp-up pulse rising up to a sustain voltage Vs to the scan electrode Y. The first ramp pulse applying unit 300 applies the first ramp-up pulse, generated by turning-on a tenth switch S10 that is the first setup switch operating in an active region, to the scan electrode Y. That is, the first ramp pulse applying unit 300 in the first embodiment of the present invention needs a separate first setup voltage source Vsetup1, however, the first ramp pulse applying unit 300 in the second embodiment of the present invention generates the first ramp-up pulse with the sustain voltage Vs without a separate first setup voltage source Vsetup1.

The voltage applying unit 400 applies a first negative voltage V1 to the sustain electrode while the first ramp-up pulse is applied to the scan electrode Y. The voltage applying unit 400 applies the first negative voltage V1 to the sustain electrode Z by turning-on of a ninth switch S9 that is the switch for applying voltage. At this time, preferably, the first negative voltage V1 is a negative sustain voltage −Vs. The sustain voltage Vs is a voltage for sustaining the sustain discharge of the plasma display panel.

The second ramp pulse applying unit 500 applies a second ramp-up pulse rising up to the sustain voltage Vs to the sustain electrode Z, after the first negative voltage V1 is applied. At this time, the second ramp pulse applying unit 500 applies the second ramp-up pulse, generated by turning-on a eleventh switch S11 that is the second setup switch operating in an active region, to the sustain electrode Z. That is, the first ramp pulse applying unit 300 in the first embodiment of the present invention needs a separate second setup voltage source Vsetup2, however, the second ramp pulse applying unit 500 in the second embodiment of the present invention generates the second ramp-up pulse with the sustain voltage Vs without a separate second setup voltage source Vsetup2.

The bias voltage applying unit 600 applies a ground level voltage to the scan electrode Y in an addressing period, after the second ramp-up pulse is applied by means of the second ramp-pulse applying unit 500. Therefore, a separate scan bias voltage source Vsc as in the first embodiment of the present invention is not needed.

The scan pulse supplying unit 700 supplies the voltage −Vw for scan pulse in order to perform an addressing on the cell positioned on the selected scan electrode. At this time, the application of the voltage for scan pulse Vw is done by turning-on a twelfth switch S12. A data pulse synchronizing with a scan pulse supplied by the scan pulse supplying unit 700 is applied to an address electrode (not shown) and thereby, an addressing is done.

The first sustain pulse supplying unit 800 supplies the energy stored in a capacitor Csl for recovering and storing energy by using a resonance between a first inductor L1 and a second inductor L2 to the scan electrode Y, and recovers it from the scan electrode Y by using a resonance between the first inductor L1 and the second inductor L2, after an addressing period, thereby supplying a sustain pulse.

The second sustain pulse supplying unit 900 applies the sustain voltage Vs, i.e., a bias voltage, to the sustain electrode Z, after the second ramp-up pulse is applied by the second ramp pulse applying unit 500, and applies the sustain pulse alternating with the sustain pulse supplied by the first sustain pulse supplying unit 800 to the sustain electrode Z.

The reference numeral 1000 is a scan driver. The scan driver 1000 Y turns-on or turns-off a thirteenth switch S13, i.e., a first selection switch, and a fourteenth switch S14, i.e., a second selection switch for applying a driving waveform to the scan electrode.

The operation associated with a driving apparatus of a plasma display penal according to the present invention will be described below in detail with reference to the drawing.

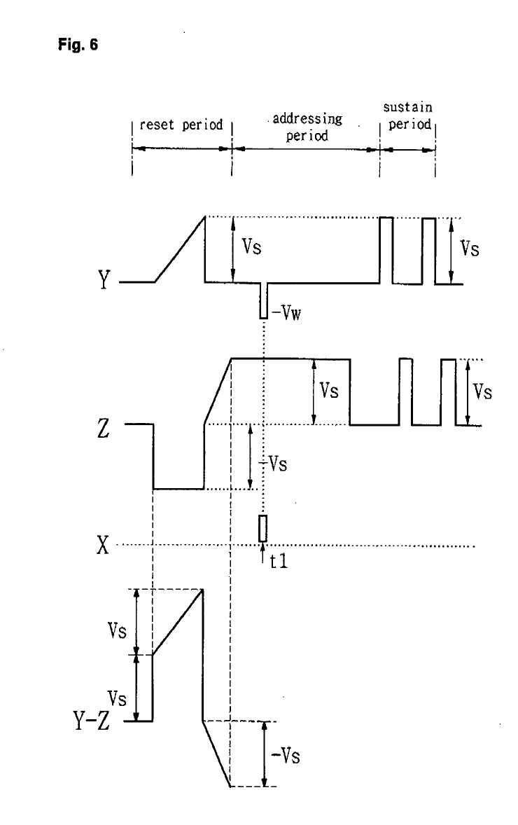

FIG. 6 is a driving waveform diagram illustrating the operation of a plasma display apparatus according to the first embodiment of the present invention.

First, the voltage applying unit 400 applies a negative sustain voltage −Vs, i.e., a first negative voltage V1, to the sustain electrode Z by turning-on the ninth switch S9 that is the switch for applying voltage. At the same time, the first ramp pulse applying unit 300 applies the first ramp-up pulse rising up to the sustain voltage Vs to the scan electrode Y.

As above, by simultaneously applying the first ramp-up pulse and the negative sustain voltage −Vs to the scan electrode Y, the potential difference between the scan electrode Y and the sustain electrode Z rises up to 2Vs in a setup period as illustrated in FIG. 6.

As above, by applying each of the first ramp-up pulse and the negative sustain voltage −Vs to the scan electrode Y and the sustain electrode Z, respectively, the sixth switch S6 included in the conventional plasma display apparatus is not needed.

Thereafter, the second ramp pulse sustain unit 500 applies the second ramp-up pulse rising up to the sustain voltage Vs to the sustain electrode Z. Therefore, the potential difference between the scan electrode Y and the sustain electrode Y falls up to the negative sustain voltage −Vs in the setup period.

Next, the bias voltage applying unit 600 applies the ground level voltage to the scan electrode Y in an addressing period. In addition, the scan pulse supplying unit 700 supplies the voltage for scan pulse −Vw, in order to perform an addressing on the cell on the selected scan line. And, the second sustain pulse supplying unit 900 applies the sustain voltage Vs to the sustain electrode Z through the turned-on sixth switch S6.

Accordingly, the ground level voltage Vsc or the voltage for scan pulse −Vw is applied to the scan electrode Y, and the sustain voltage Vs playing a role of a bias voltage is applied to the sustain electrode Z, in an addressing period, as illustrated in FIG. 4.

When the voltage for scan pulse −Vw is applied as above, the second switch S2 of the first sustain pulse supplying unit 800 becomes a turn-off status. Therefore, the plasma display apparatus of the present invention does not need a high withstand voltage switching element such as the seventh switch S7, unlike the plasma display apparatus of the conventional plasma display apparatus.

Also, since the ground level voltage is applied to the scan electrode Y through the thirteenth switch S13 of the scan driver 1000, the eighth switch S8 of the conventional driving apparatus, as illustrated in FIG. 1, is not needed. Also, as illustrated in FIG. 3, since the scan electrode Y becomes a ground level by the turn-on of the fourth switch S4 and the fourteenth switch S14, the ninth switch S9 of FIG. 1 is not needed.

### THIRD EMBODIMENT

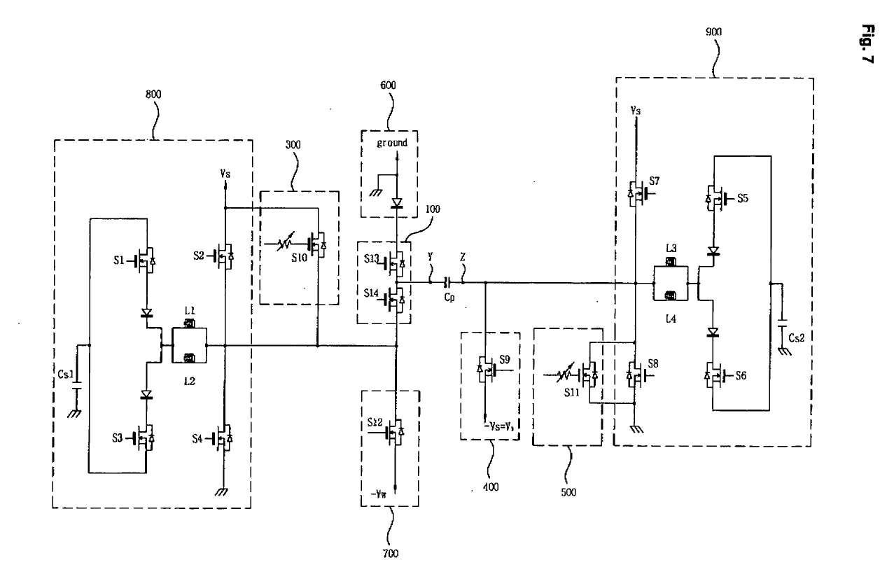

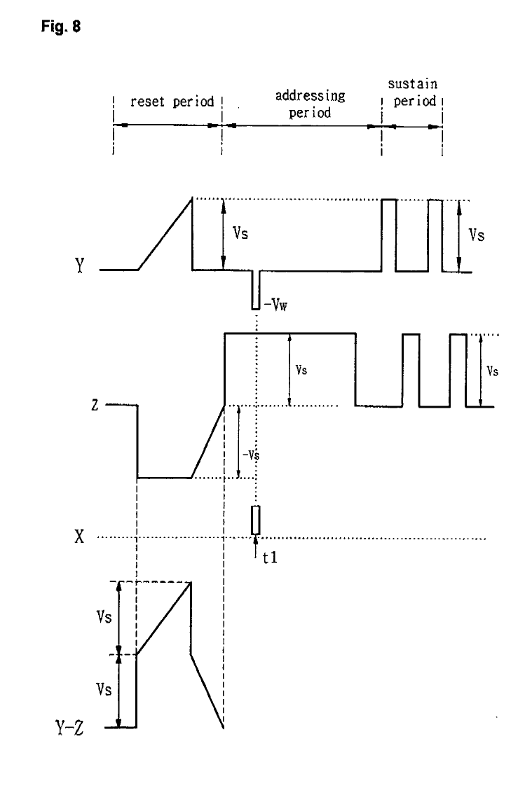

FIG. 7 is a third embodiment of a plasma display apparatus according to the present invention. FIG. 8 is a driving waveform diagram illustrating the operation of a plasma display apparatus according to the third embodiment of the present invention. The difference between the second embodiment and the third embodiment of the present invention is that the eleventh switch S11 of the second ramp pulse applying unit 500 is connected in parallel to the eighth switch S8 of the second sustain pulse supplying unit 900.

If the eleventh switch S11 of the second ramp waveform supplying unit 350 is connected in parallel to the eighth switch S8, as illustrated in FIG. 8, after the negative sustain voltage −Vs is applied to the sustain electrode Y, the eleventh switch generates the second ramp-up pulse with being turned-on. At this time, the potential of the sustain electrode Y rises from the negative sustain voltage −Vs to the ground. Thereafter, the seventh switch S7 turns-on so that the sustain voltage Vs is applied to the sustain electrode Z.

Accordingly, the potential difference between the scan electrode Y and the sustain electrode Z rises up to the 2Vs in the setup period, and falls up to the ground level in the setdown period.

The invention being thus described, it will be obvious that the same may be varied in may ways. Such variations are not to be regarded as departure from the spirit and scope of the invention, and all such modifications as would be obvious to one skilled in the art intended to be included within the scope of the following claims.

What is claimed is:

1. A plasma display apparatus comprising:
a plasma display panel comprising a scan electrode and a sustain electrode;
a first ramp pulse applying unit applying a first ramp-up pulse to the scan electrode;
a voltage applying unit applying a first negative voltage to the sustain electrode while the first ramp-up pulse is applied to the scan electrode; and
a second ramp pulse applying unit applying a second ramp-up pulse to the sustain electrode after the first negative voltage is applied.

2. The plasma display apparatus of claim 1, wherein the first ramp pulse applying unit applies a first ramp-up pulse rising from a ground level voltage to a first setup voltage to the scan electrode.

3. The plasma display apparatus of claim 2, the first ramp pulse applying unit comprises a first setup switch, which generates the first ramp-up pulse by the first setup voltage applied to one terminal thereof and applies the first ramp-up pulse to the scan electrode through other terminal thereof.

4. The plasma display apparatus of claim 1, wherein the first ramp pulse applying unit applies the first ramp-up pulse rising from a ground level voltage to a sustain voltage to the scan electrode.

5. The plasma display apparatus of claim 4, wherein the first ramp pulse applying unit comprises a first setup switch, which generates the first ramp-up pulse by the sustain voltage applied to one terminal thereof and applies the first ramp-up pulse to the scan electrode through other terminal thereof.

6. The plasma display apparatus of claim 1, wherein the second ramp pulse applying unit applies a second ramp-up pulse rising from a ground level voltage to a second setup voltage to the sustain electrode.

7. The plasma display apparatus of claim 6, wherein the second ramp pulse applying unit comprises a second setup switch, which generates the second ramp-up pulse by the second setup voltage applied to one terminal thereof and applies the second ramp-up pulse to the sustain electrode through other terminal thereof.

8. The plasma display apparatus of claim 1, wherein the second ramp pulse applying unit applies the second ramp-up pulse rising from a ground level voltage to a sustain voltage to the sustain electrode.

9. The plasma display apparatus of claim 8, wherein the second ramp pulse applying unit comprises a second setup switch, which generates the second ramp-up pulse by the second sustain voltage applied to one terminal thereof and applies the second ramp-up pulse to the sustain electrode through other terminal thereof.

10. The plasma display apparatus of claim 1, wherein the second ramp pulse applying unit comprises a bias voltage applying unit applying a ground level voltage to the scan electrode, after applying the second ramp-up pulse.

11. The plasma display apparatus of claim 1, wherein further comprising a sustain pulse supplying unit applying a sustain pulse to the sustain electrode; and,
the second ramp pulse applying unit applies the second ramp-up pulse when the sustain pulse supplying unit recovers energy from the sustain electrode.

12. The plasma display apparatus of claim 11, wherein the second ramp pulse applying unit comprises a second setup switch being turned-on upon recovering the energy, by connecting one terminal thereof to the sustain electrode and the other terminal thereof to the ground.
the second ramp pulse applying unit comprise a second setup switch being turned-on, when the energy is recovered, by means that one end is connected to the sustain electrode and another end is connected to the ground.

13. The plasma display apparatus of claim 3, wherein the first setup switch operates in an active region.

14. The plasma display apparatus of claim 7, wherein the second setup switch operates in an active region.

15. A driving method of a plasma display apparatus including the steps of:
applying a first ramp-up pulse to a first scan electrode;
applying a first negative voltage to a sustain electrode while the first ramp-up pulse is applied to the scan electrode; and,
applying a second ramp-up pulse to the sustain electrode after the first negative voltage is applied.

16. The driving method of a plasma display apparatus of claim 15, wherein the first ramp-up pulse rises from a ground level to a first setup voltage.

17. The driving method of a plasma display apparatus of claim 15, wherein the first ramp-up pulse rises from a ground level to a sustain voltage.

18. The driving method of a plasma display apparatus of claim 15, wherein the second ramp-up pulse rises from a ground level to a second setup voltage.

19. The driving method of a plasma display apparatus of claim 15, wherein the second ramp-up pulse rises from a negative sustain voltage to a ground level.

20. The driving method of a plasma display apparatus of claim 15, wherein further including applying a ground level voltage to the scan electrode after applying the second ramp-up pulse.
